(19) United States
(12) Patent Application Publication
(10) Pub. No.: US 2014/0176085 A1
(43) Pub. Date: Jun. 26, 2014

(54) BATTERY CONTROLLER OF VEHICLE

(71) Applicants: Naoki Maruno, Haga-gun (JP); Satoru Komoda, Haga-gun (JP)

(72) Inventors: Naoki Maruno, Haga-gun (JP); Satoru Komoda, Haga-gun (JP)

(73) Assignee: Honda Motor Co., Ltd., Tokyo (JP)

(21) Appl. No.: 13/989,658

(22) PCT Filed: Aug. 17, 2012
(86) PCT No.: PCT/JP2012/070901

§ 371 Date: May 24, 2013

(30) Foreign Application Priority Data
Sep. 7, 2011 (JP) 2011-194728

(51) Int. Cl. B60L 11/18

(52) U.S. Cl. CPC B60L 11/1811; B60L 11/1861
USPC 320/162

(57) ABSTRACT

This battery controller of a vehicle includes an internal combustion engine, a generator; a battery; a battery state detector that detects a battery state including the remaining capacity of the battery; a degree-of-deterioration determination unit that determines the degree of deterioration of the battery based on the battery state; a neglect state detector; a monitoring time setting unit that sets a monitoring time to monitor the remaining capacity based on the degree of deterioration and the current remaining capacity of the battery when the neglect state of the vehicle is detected by the neglect state detector; and a charging necessity determination unit that determines whether or not the battery needs to be charged after the monitoring time set by the monitoring time setting unit passes. Charging of the battery by the generator is started when the charging necessity determination unit determines that the battery needs to be charged.

### TECHNICAL FIELD

This invention relates to a battery controller of a vehicle.

Priority is claimed on Japanese Patent Application No. 2011-194728, filed Sep. 7, 2011, the content of which is incorporated herein by reference.

### BACKGROUND ART

In the related art, in a battery controller of a vehicle that charges a battery by driving a generator using an internal combustion engine, the remaining capacity (SOC; State Of Charge) of the battery is reduced due to self-discharge, dark current, and the like during a period for which the vehicle is stopped. Therefore, in order to prevent a situation where the internal combustion engine can no longer be started due to a long-term stop (hereinafter, referred to as “neglect”), a technique to calculate the lower limit of the available range in the SOC of the battery in consideration of the amount of discharge and control the SOC so as not to become less than the lower limit of the available range has been proposed (for example, refer to Patent Document 1). In addition, a region below the lower limit of the available range of the SOC is an over-discharge region.

### CITATION LIST

### Patent Document

[Patent Document 1] Japanese Unexamined Patent Application, First Publication No. 2005-253287

### SUMMARY OF INVENTION

### Technical Problem

Meanwhile, in the battery controller of a vehicle described above, the rate of self-discharge of the battery is changed using the predicted value of the average temperature of the stop period or the like. However, the last stop period is used as the predicted value (current value) of the stop period. For this reason, when the stop period is irregular, for example, when an unintentional long-term business trip or long-term hospitalization occurs, there is a possibility that the SOC will be decreased up to the over-discharge region due to self-discharge of the battery and dark current of an in-vehicle apparatus and the like and accordingly the service life of the battery will be shortened.

This invention has been made in view of the above-described situation, and it is an object of the invention to provide a battery controller of a vehicle capable of suppressing the shortening of the service life of a battery by reducing the burden on the battery by preventing the SOC of the battery from decreasing up to the over-discharge region even if the vehicle stop period is irregular.

### Solution to Problem

In order to solve the above-described problem and achieve the object, the invention adopts the following measures.

(1) A battery controller of a vehicle according to an aspect of the present invention includes: an internal combustion engine; a generator that generates electricity by the driving of the internal combustion engine; a battery charged by an electric power generated by the generator; a battery state detector that detects a battery state including a remaining capacity of the battery; a degree-of-deterioration determination unit that determines a degree of deterioration of the battery based on the battery state detected by the battery state detector; a neglect state detector that detects a neglect state of the vehicle; a monitoring time setting unit that sets a monitoring time to monitor the remaining capacity based on the degree of deterioration determined by the degree-of-deterioration determination unit and a current remaining capacity of the battery detected by the battery state detector when the neglect state of the vehicle is detected by the neglect state detector; and a charging necessity determination unit that determines whether or not the battery needs to be charged after the monitoring time set by the monitoring time setting unit passes. Charging of the battery by the generator is started when the charging necessity determination unit determines that the battery needs to be charged.

(2) In the battery controller of the vehicle described in the above (1), the monitoring time setting unit may calculate an available range of a full capacity of the battery based on the degree of deterioration determined by the degree-of-deterioration determination unit, and set the monitoring time based on the available range and the current remaining capacity of the battery.

(3) The battery controller of the vehicle described in the above (2) may further include a charge target value setting unit that sets a target value of an amount of charging of the battery based on the available range. The charging of the battery by the generator may be controlled based on the target value set by the charge target value setting unit.

(4) In the battery controller of the vehicle described in any one of the above (1) to (3), the monitoring time setting unit may set the monitoring time according to the degree of deterioration.

(5) In the battery controller of the vehicle described in any one of the above (1) to (4), the charging necessity determination unit may determine whether or not the battery needs to be charged when an ignition switch is turned off, makes the battery be charged by the generator when the charging necessity determination unit determines that the battery needs to be charged, and stop the internal combustion engine after the charging of the battery ends.

(6) The battery controller of the vehicle described in any one of the above (1) to (5) may further include a notification unit that notifies that the battery is being charged by the generator.

(7) In the battery controller of the vehicle described in any one of the above (1) to (6), the monitoring time setting unit may set a new monitoring time whenever the monitoring time passes.

(8) In the battery controller of the vehicle described in any one of the above (1) to (7), the neglect state detector may detect the neglect state when a predetermined time for detecting the neglect state has passed in a state where an ignition switch is off.

(9) The battery controller of the vehicle described in any one of the above (1) to (8) may further include a neglect operation input unit capable of inputting an indication that the vehicle is to be in the neglect state. The neglect state detector may detect the neglect state when there is an operation input to the neglect operation input unit.

### Advantageous Effects of Invention

According to the battery controller of a vehicle described in the above (1), when the neglect state of a vehicle is detected by the neglect state detector, the monitoring time is set based on the degree of deterioration of the battery and the current remaining capacity of the battery, and it is determined whether or not the battery needs to be charged by the charging necessity determination unit in order to monitor the remaining capacity of the battery after the passage of the monitoring time. For this reason, even if unintentional neglect of the vehicle occurs, it is possible to determine whether or not charging is necessary in appropriate monitoring time according to the degree of deterioration of the battery. Accordingly, the battery can be charged by the generator before the battery is over-discharged. Therefore, since the burden on the battery is reduced, shortening of the service life can be suppressed. In addition, since the remaining capacity of the battery is monitored after the passage of the monitoring time, it is possible to suppress the power consumption according to monitoring and accordingly to save energy, compared with a case where the remaining capacity of the battery is always monitored.

According to the battery controller of a vehicle described in the above (2), since the monitoring time is set based on the available range and the current remaining capacity of the battery, it is possible to set the monitoring time so that the battery is charged by the generator before the remaining capacity of the battery deviates from the available range. For this reason, it is possible to prevent a situation where the remaining capacity becomes less than the available range before the passage of monitoring time and accordingly the battery is over-discharged.

According to the battery controller of a vehicle described in the above (3), since charging is stopped when it is determined that the remaining capacity has become equal to or higher than the target value, it is possible to perform charging so as not to exceed the available range when charging the battery. Accordingly, it is possible to prevent an increase in the burden on the battery due to overcharging, and suppress the shortening of the service life of the battery.

According to the battery controller of a vehicle described in the above (4), when the vehicle is in a neglect state, time until the remaining capacity reaches the lower limit of the available range becomes shorter as the degree of deterioration of the battery becomes higher compared with a new battery. Therefore, the monitoring time can be set to be short according to this degree of deterioration. For this reason, even if the deterioration of the battery is in process, it is possible to prevent the battery from becoming over-discharged by charging the battery in a timely manner before the remaining capacity of the battery becomes less than the lower limit of the available range. Therefore, it is possible to further suppress the shortening of the service life.

According to the battery controller of a vehicle described in the above (5), when the remaining capacity of the battery when the ignition switch is turned off is a remaining capacity that needs charging, it is possible to charge the battery in a state where the internal combustion engine is still warm without stopping the internal combustion engine. Therefore, compared with a case of charging the battery by driving the internal combustion engine in a cold state immediately after start, it is possible to reduce exhaust emissions and to further improve the fuel efficiency.

According to the battery controller of a vehicle described in the above (6), it is possible to notify an operator that the internal combustion engine is being driven to charge the battery when opening the engine compartment of the vehicle for maintenance or the like. Therefore, it is possible to reduce the burden of the operator under work to check the situation or the like.

According to the battery controller of a vehicle described in the above (7), whenever the monitoring time passes, it is possible to compare the monitoring time set based on the degree of deterioration with the optimal monitoring time based on the reduction speed of the actual remaining capacity and to correct the deviation of the monitoring time. Therefore, it is possible to prevent the remaining capacity from becoming less than the lower limit of the available range by monitoring the remaining capacity of the battery in a timely manner.

According to the battery controller of a vehicle described in the above (8), it is possible to detect that the vehicle is in a neglect state when predetermined time has passed after the ignition switch is turned off. Therefore, even if the vehicle is unintentionally neglected for a long period of time, it is possible to prevent the battery from becoming over-discharged by appropriately monitoring the remaining capacity of the battery.

According to the battery controller of a vehicle described in the above (9), immediately after there is a neglect operation input indicating that the vehicle is in a neglect state, the remaining capacity of the battery can be monitored in a timely manner so that the remaining capacity of the battery is in an appropriate state.

### BRIEF DESCRIPTION OF DRAWINGS

FIG. 1 is a block diagram of a series type hybrid vehicle including a battery controller according to an embodiment of the present invention.

FIG. 2 is a block diagram of the battery controller according to the embodiment.

FIG. 3 is a graph showing a change in the SOC over the number of days elapsed.

FIG. 4 is a graph showing a change in the amount of reduction in the SOC per day over the number of days elapsed.

FIG. 5 is a flow chart showing the charge control process after a stop.

FIG. 6 is a flow chart showing the control process in a neglect mode.

FIG. 7 is a timing chart in the case of a new battery.

FIG. 8 is a timing chart when a battery has deteriorated.

### DESCRIPTION OF EMBODIMENTS

A battery controller of a vehicle according to an embodiment of the present invention will be described with reference to the drawings.

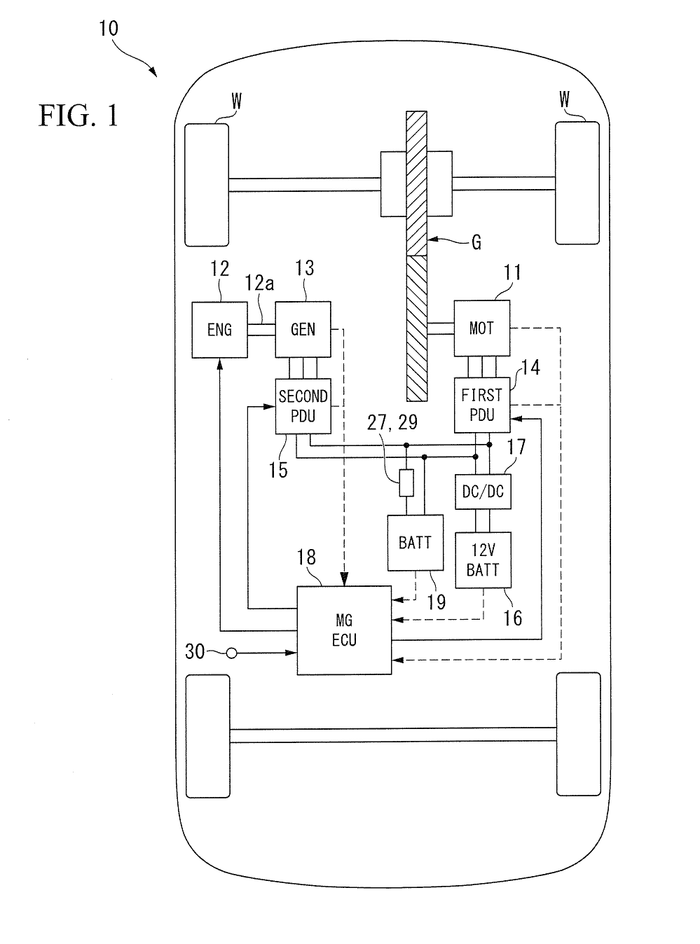

FIG. 1 shows the schematic configuration of a hybrid vehicle 10 including the battery controller according to the present embodiment. The hybrid vehicle 10 is a so-called series type hybrid vehicle in which a drive motor (MOT) 11 is linked to a drive wheel W through a power transmission mechanism G and a rotor of a motor for power generation (GEN) 13, which is a generator, is connected to a crank shaft 12a of an internal combustion engine (ENG) 12 so that they rotate integrally, for example.

The drive motor 11 and the motor for power generation 13 are three-phase brushless DC motors, for example. The drive motor 11 is connected to a first power drive unit (first PDU) 14 that controls the drive motor 11, and the motor for power generation 13 is connected to a second power drive unit (second PDU) 15 that controls the motor for power generation 13.

Each of the first and second power drive units 14 and 15 is configured to include a PWM inverter for pulse width modulation (PWM) that includes a bridge circuit formed by a bridge connection using a plurality of switching elements, such as transistors, for example.

The first and second power drive units 14 and 15 are connected to a high-voltage battery 19, such as a lithium ion (Li-ion) battery. For example, when driving the drive motor 11, the first power drive unit 14 converts DC power, which is supplied from the high-voltage battery 19 or the second power drive unit 15 of the motor for power generation 13, into AC power and supplies it to the drive motor 11.

In addition, for example, when the motor for power generation 13 generates electricity with the power of the internal combustion engine 12, the second power drive unit 15 converts AC power output from the motor for power generation 13 into DC power and charges the high-voltage battery 19 or supplies the electric power to the first power drive unit 14 of the drive motor 11.

In addition, when the driving force is transmitted from the driving wheel W side to the drive motor 11 side, for example, during deceleration of the hybrid vehicle 1, the drive motor 11 functions as a generator to generate so-called regenerative braking force, and recovers the kinetic energy of the vehicle as electrical energy. During power generation of the drive motor 11, the first power drive unit 14 converts the generated (regenerative) AC power, which is output from the drive motor 11, into DC power and charges the high-voltage battery 19.

A low-voltage battery (12V BATT) 16 for driving the electric load including various auxiliary devices is connected to a DC/DC converter (DC/DC) 17. The DC/DC converter 17 is connected to the first power drive unit 14, the second power drive unit 15, and the high-voltage battery 19.

The DC/DC converter 17 can charge the low-voltage battery 16 by stepping down the voltage between terminals of the high-voltage battery 19 or the voltage between terminals of the first and second power drive units 14 and 15 to a predetermined voltage value.

For example, when the remaining capacity (SOC: State Of Charge) of the high-voltage battery 19 is decreasing, the voltage between the terminals of the low-voltage battery 16 may be boosted to charge the high-voltage battery 19.

In addition, in the present embodiment, the hybrid vehicle 10 includes an MGECU 18 (control unit) that performs overall control of the hybrid vehicle 10 as an ECU (Electronic Control Unit) formed by electronic circuits, such as a CPU (Central Processing Unit), for example. Switching control of the first and second power drive units 14 and 15 is performed by the control signal of the MGECU 18.

In addition, the MGECU 18 has functions as a monitoring time setting unit, a neglect state detector, a degree-of-deterioration determination unit, a charging necessity determination unit, and a charge target value setting unit. In addition, the MGECU 18 controls the notification of a notification unit.

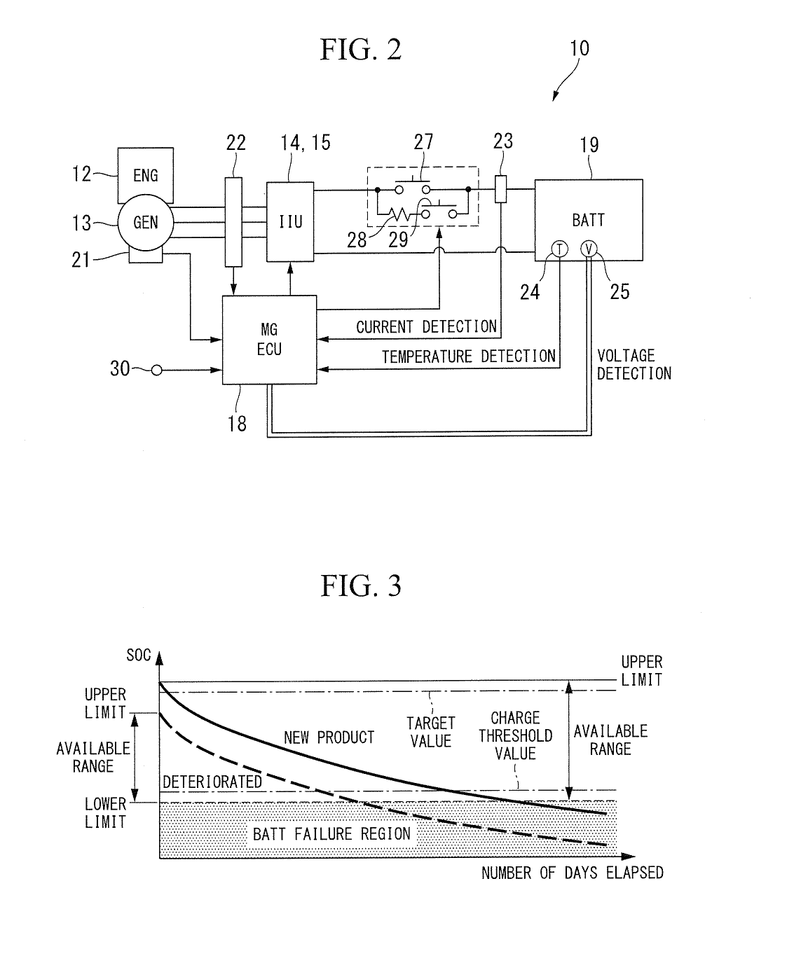

Further explanation will be given referring to FIG. 2 together with FIG. 1. The hybrid vehicle 10 includes a rotation sensor 21 that detects the number of revolutions of a rotor of the motor for power generation 13, a phase current sensor 22 that detects the phase current of three phases of the motor for power generation 13, and a battery current sensor 23 that detects a current flowing into the battery 19 and a current flowing from the battery 19. The information of the detection results of the rotation sensor 21, the phase current sensor 22, and the battery current sensor 23 is input to the MGECU 18. In the present embodiment, a neglect operation input unit 30 operated to input when a user neglects the hybrid vehicle 10 in a stopped state is provided in the hybrid vehicle 10. The input information of the neglect operation input unit 30 is input to the MGECU 18. In FIG. 2, a unit obtained by integrating the first and second power drive units 14 and 15, each of which includes an inverter, is written as an “IIU”.

The battery 19 includes a battery temperature sensor 24 that detects the temperature of the battery 19 and a battery voltage sensor 25 that detects the terminal voltage of the battery 19. The information of the detection result of the battery temperature sensor 24 and the detection result of the battery voltage sensor 25 is input to the MGECU 18.

In the power line connecting the first and second power drive units 14 and 15 and the battery 19, a contactor 27 for electrically disconnecting the battery 19 is interposed between the first and second power drive units 14 and 15 and the battery current sensor 23. A precharge contactor 29 is connected in parallel to the contactor 27, and a precharge resistor 28 is connected in series to the precharge contactor 29. The contactor 27 and the precharge contactor 29 are controlled to be opened and closed by the MGECU 18. For example, when electrically connecting the battery 19 to the first and second power drive units 14 and 15, the contactor is turned ON after the precharge contactor 29 is turned ON (connected) from the state where both the contactor 27 and the precharge contactor 29 are OFF (disconnected). Through this configuration, inrush current from the battery 19 to the first and second power drive units 14 and 15 is prevented.

The MGECU 18 controls the amount of power generated by the motor for power generation 13 by controlling the driving of the internal combustion engine 12 based on the number of revolutions detected by the rotation sensor 21 and the phase current of the motor for power generation 13 detected by the phase current sensor 22.

In addition, the MGECU 18 performs control to count the number of times of charging and discharging of the battery 19 (hereinafter, simply referred to as the number of times of charging and discharging) and store it in a storage unit, such as a nonvolatile memory.

The MGECU 18 derives the degree of deterioration of the battery 19 based on the terminal voltage of the battery 19 acquired from each sensor described above (hereinafter, simply referred to as a terminal voltage), current flowing due to the charging and discharging of the battery 19 (hereinafter, simply referred to as a charging and discharging current), and the information of various battery states such as the battery temperature. Here, the degree of deterioration of the battery 19 indicates the grade of deterioration of the battery 19. An increase in the degree of deterioration causes an increase in internal resistance or the like and accordingly the terminal voltage is reduced or the charging and discharging current is reduced. Generally, when the environment of the battery 19 is constant, the degree of deterioration of the battery 19 gradually increases as the number of times of charging and discharging increases.

The degree of deterioration of the battery 19 is derived based on the detection results of the battery current sensor 23, the battery temperature sensor 24, and the battery voltage sensor 25 and the number of times of charging and discharging, which is stored in a storage unit, referring to a map (not shown) between the degree of deterioration and the terminal voltage, the charging and discharging current, the battery temperature, and the number of times of charging and discharging stored in advance in a storage unit such as a nonvolatile memory. Here, the terminal voltage decreases as the degree of deterioration increases, and the charging and discharging current decreases as the degree of deterioration increases. In addition, the charging and discharging current flows easily when the battery temperature is relatively high.

In addition, the MGECU 18 calculates the SOC indicating the remaining capacity (state of charge) of the battery 19 based on the charging and discharging current detected by the battery current sensor 23. In addition, the MGECU 18 derives an available range of the total battery capacity (100%) of the battery 19 (hereinafter, simply referred to as an available range) based on the degree of deterioration described above. Here, the available range represents the percentage (%) of the SOC at which optimal charging and discharging can be performed without imposing a heavy burden on the battery 19, and is defined by the upper limit (%) and the lower limit (available lower limit) (%). This available range is derived by referring to the map (not shown) between the degree of deterioration and the available range stored in advance in a storage unit, such as a nonvolatile memory. The degree of deterioration and the available range of the battery 19 may also be calculated using, for example, a table or expression instead of a map.

FIG. 3 is a graph showing a change in the SOC of the new battery 19 over the number of days elapsed (shown by the solid line in FIG. 3) and a change in the SOC of the battery 19 that has deteriorated to some extent (shown by the broken line in FIG. 3). As shown in this graph, if the battery 19 is neglected in a state where the charging is not performed, the SOC gradually decreases over time due to self-discharge or dark current of an in-vehicle apparatus or the like. When the deteriorated battery 19 is compared with the new battery 19, there is no difference in the lower limit of the available range. However, the upper limit of the available range of the deteriorated battery 19 is lower than the upper limit of the available range of the new battery 19. In any case of the new battery 19 and the battery 19 that has deteriorated, there is a possibility that the burden on the battery 19 will be increased since the SOC enters a battery failure region, which is an over-discharge region lower than the lower limit of the available range, or enters an overcharge region higher than the upper limit and accordingly the service life will be noticeably shortened.

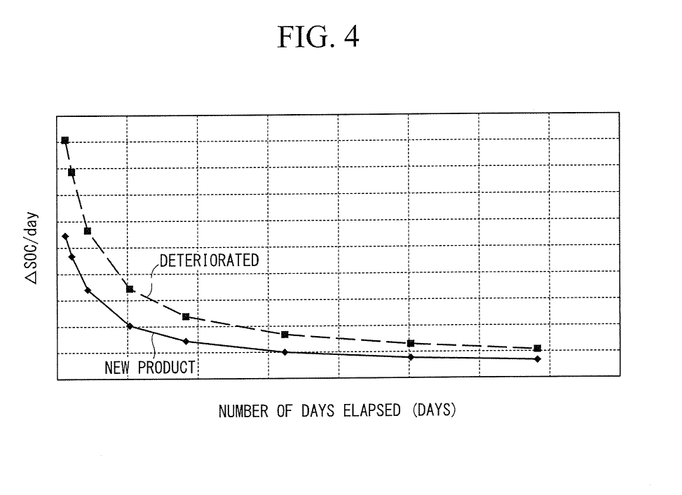

FIG. 4 is a graph showing an example of the amount of reduction in the SOC per day (ΔSOC/day) over the number of days elapsed. In this drawing, a solid line shows the new battery 19, and the broken line shows the battery 19 that has deteriorated to some extent. As shown in this graph, the amount of reduction in the SOC of both the new battery 19 and the deteriorated battery 19 per day (ΔSOC/day) decreases with the number of days elapsed. In addition, when the new battery 19 is compared with the deteriorated battery 19, the amount of reduction in the SOC of the deteriorated battery 19 per day is larger than that of the new battery 19 in all days elapsed. That is, as the deterioration of the battery 19 progresses, the width of the upper and lower limits of the available range is decreased and the amount of reduction in the SOC per day is also increased. Accordingly, when the battery 19 is neglected after charging, time until the SOC reaches the lower limit becomes shorter as the degree of deterioration of the battery 19 becomes larger due to self-discharge and the like.

The MGECU 18 sets the monitoring time for measuring the timing to monitor the SOC of the battery 19 based on the current SOC of the battery 19 and the available range described above. This monitoring time is a time until the next monitoring, and is set to be shorter as the degree of deterioration of the SOC of the battery 19 becomes larger. The MGECU 18 executes the SOC monitoring process when the set monitoring time has passed, and resets the monitoring time from the current SOC and the available range whenever the monitoring time that is currently set passes. In this manner, the monitoring of the SOC is repeatedly executed by the MGECU 18.

Here, the SOC monitoring is control processing for determining whether or not the SOC is less than the lower limit of the available range. However, the burden of the battery 19 is increased when the SOC becomes less than the lower limit. In practice, therefore, the determination is performed by comparing the SOC with a charge threshold value (refer to FIG. 3), which is a threshold value of the SOC set to be slightly higher (for example, 5% to 10% higher) than the lower limit of the available range.

In addition, the MGECU 18 monitors the ON/OFF state of an ignition switch (not shown) of the hybrid vehicle 10. When the ignition switch shifts from the ON state to the OFF state and the neglect state of the hybrid vehicle 10 is detected, the MGECU 18 counts the monitoring time and monitors the SOC when the monitoring time has passed. In this case, when it is determined that the SOC is likely to be less than the lower limit of the available range, that is, when it is determined that the SOC is less than the charge threshold value, the MGECU 18 starts charge control to charge the battery 19.

When the charge control with respect to the battery 19 is started, the MGECU 18 performs control to charge the battery 19 by turning the motor for power generation 13 by driving of the internal combustion engine 12 and performing voltage conversion of electric power, which is generated by the motor for power generation 13, using the second power drive unit 15. At the time of this charge control, it is determined whether or not the SOC of the battery 19 is likely to exceed the upper limit of the available range. When it is determined that the SOC of the battery 19 is likely to exceed the upper limit, the MGECU 18 stops the internal combustion engine 12 to stop charging the battery 19. Here, determination regarding whether or not the SOC is likely to exceed the upper limit of the available range is performed by comparing the SOC with a predetermined target value, which is slightly lower (for example, 5% to 10% lower) than the upper limit, so that the SOC does not exceed the upper limit. This target value is set by the charge target value setting unit.

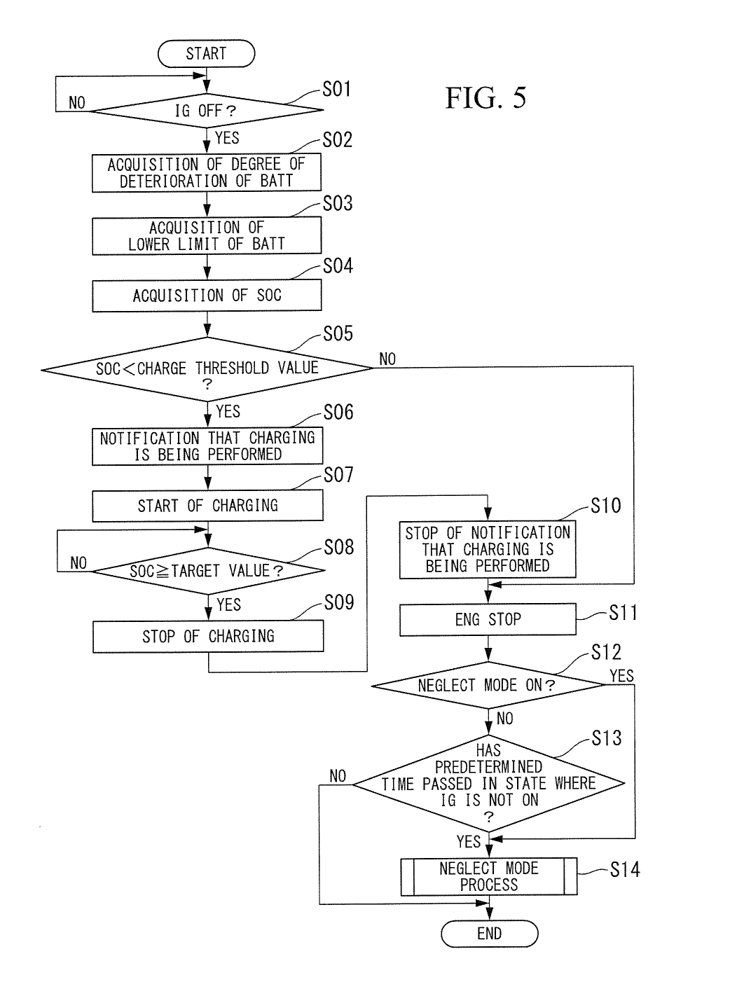

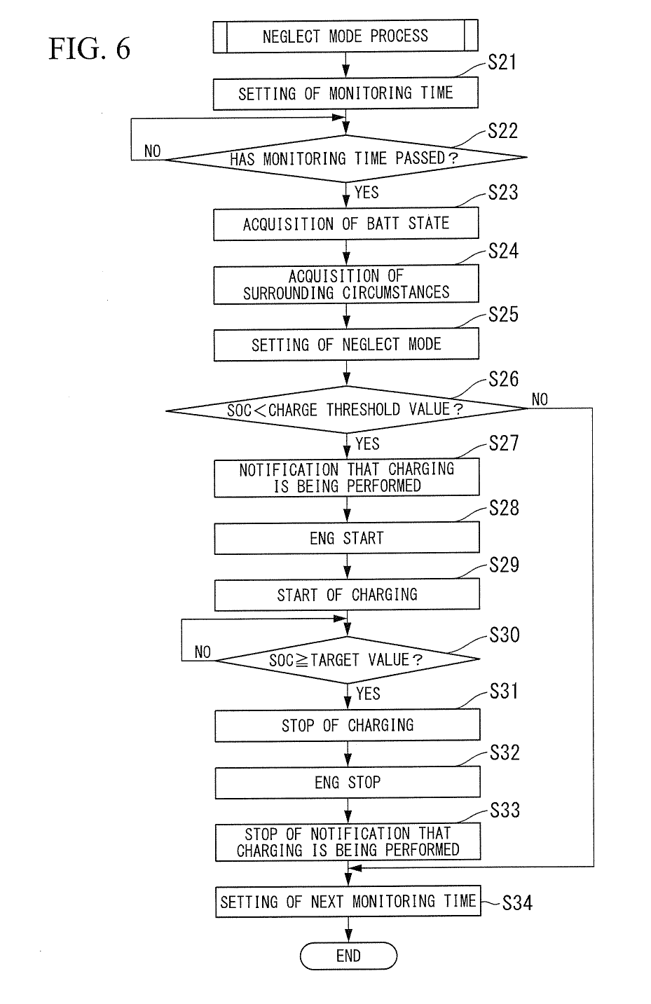

The battery controller according to the present embodiment has the above-described configuration. Next, the operation of this battery controller will be described with reference to the flow charts shown in FIGS. 5 and 6.

The flow chart shown in FIG. 5 is a main flow of the charging and discharging control of the battery 19 which is performed after the stop of the hybrid vehicle 10. First, in step S01, it is determined whether the ignition switch (IG) has switched from the ON state to the OFF state. If the result of this determination is “Yes” (IG has switched from ON to OFF), the process proceeds to step S02. If “No” (IG has not switched from ON to OFF), the process of step S01 is repeated.

In step S02, from the information of the battery state, such as terminal voltage, charging and discharging current, and battery temperature, the degree of deterioration of the battery (BATT) 19 is determined from the map or the like and acquired (function as a degree-of-deterioration determination unit).

Then, in step S03, the available range of the battery 19, in particular, the lower limit (lower limit of the BATT) is calculated from the degree of deterioration determined in step S02 and acquired.

In step S04, the current SOC of the battery 19 is acquired based on the charging and discharging current and the like.

In step S05, it is determined whether or not the current SOC calculated in step S04 is smaller than the charge threshold value. In addition, the charge threshold value is calculated from the lower limit of the available range. If the determination result in step S05 is “Yes” (SOC<charge threshold value), the process proceeds to step S06. If “No” (SOC≧charge threshold value), the process proceeds to step S11. In the state where the ignition switch is ON, charging and discharging control is performed such that the SOC is not less than the lower limit. Accordingly, even if the SOC becomes less than the charge threshold value, the SOC is not less than the lower limit.

In step S06, the fact that the battery 19 is being charged, for example, by flashing of a hazard lamp, text display on an in-vehicle display, or voice output from a notification unit, such as an in-vehicle speaker, is notified.

In step S07, the motor for power generation 13 is driven by the internal combustion engine 12, and charging of the battery 19 is started using the electric power generated by the motor for power generation 13.

In step S08, it is determined whether or not the SOC is equal to or higher than the predetermined target value that is slightly lower than the upper limit of the available range (function as a charge target value setting unit). If the determination result is “Yes” (SOC≧target value), the process proceeds to step S08. If “No” (SOC<target value), the process proceeds to step S09.

In step S09, charging of the battery 19 is stopped since the SOC is equal to or higher than the target value. Then, in step S10, a notification indicating that the battery 19 is being charged is stopped.

In step S11, driving of the internal combustion engine 12 is stopped.

In step S12, it is determined whether or not the neglect mode is ON. Here, the neglect mode is a mode that is started, for example, when the user knows in advance that the hybrid vehicle 10 is scheduled to be neglected (in a neglect state) for a long period of time, by inputting that through a user interface, such as a touch panel. Details of the neglect mode will be described later.

If the determination result in step S12 is “Yes” (neglect mode), the process proceeds to step S14. If “No” (not the neglect mode), a subroutine of the neglect mode in step S13 is executed and then the series of processes described above are once ended. In step S13, it is determined whether or not a predetermined time set in advance in a state where the ignition switch is OFF has passed. Here, the predetermined time is a threshold time that is set in advance in order to detect the long-term neglect of the hybrid vehicle 10, which is not intended by the user, due to a sudden long-term business trip or long-term hospitalization, for example. As this threshold time, it is possible to set an appropriate period (for example, 1 month) for which the SOC of the battery 19 is not less than the lower limit of the available range (function as a neglect state detector).

If the determination result in step S13 is “Yes” (predetermined time has passed), the process proceeds to step S14 to execute a neglect mode process and then the series of processes described above are once ended. On the other hand, if the determination result is “No” (predetermined time has not passed), the series of processes described above are ended temporarily without executing the process of step S14.

Next, the operation of the battery controller in the neglect mode process of step S14 of FIG. 5 will be described with reference to the flow charts shown in FIG. 6.

First, in step S21 shown in FIG. 6, the monitoring time is set based on the available range and the current SOC of the battery 19, and a counting process based on this monitoring time is started (function as a monitoring time setting unit).

In step S22, it is determined whether or not the set monitoring time has passed. If the determination result is “Yes” (monitoring time has passed), the process proceeds to step S23. If “No” (monitoring time has not passed), the process of step S22 is repeated. Due to these processes of steps S21 and S22, it is possible to prevent the SOC of the battery 19 from becoming less than the lower limit before the monitoring time passes.

In step S23, the information of the battery state, such as the number of times of charging and discharging, the terminal voltage, the charging and discharging current, the battery temperature, and the battery use time, is acquired.

In step S24, a surrounding conditions acquisition unit (not shown) including an outside air temperature sensor acquires the information of the surrounding conditions of the hybrid vehicle 10, such as the outside air temperature. The monitoring time can be corrected using the information of the battery state or the surrounding conditions, which has been acquired by the processes of steps S23 and S24.

In the step S25, the neglect mode is set. By setting the neglect mode, for example, a flag indicating whether or not the mode is a neglect mode is set from “0” to “1”.

In step S26, it is determined whether or not the SOC has become less than the charge threshold value (function as a charging necessity determination unit). If this determination result is “Yes” (SOC<charge threshold value), the process proceeds to step S27. If “No” (SOC≧charge threshold value), the process proceeds to step S34. Here, when it is determined that the SOC has become less than the charge threshold value in step S34, an appropriate monitoring time according to the state of the current battery 19 is set.

In step S27, a notification indicating that the battery 19 is being charged is sent, in the same manner as in step S06 described above. In step S28, the internal combustion engine 12 is started to start the power generation of the motor for power generation 13. In step S29, charging of the battery 19 is started.

In step S30, it is determined whether or not the SOC has become equal to or higher than the target value, in the same manner as in step S08 described above. If the determination result is “Yes” (SOC≧target value), the process proceeds to step S31. If “No” (SOC<target value), the process of step S30 is repeated. Due to step S30, overcharging of the battery 19 can be prevented.

In step S31, charging is stopped. Then, in step S32, the internal combustion engine 12 is stopped. In step S33, the notification indicating that the battery 19 is being charged is stopped.

In step S34, the next monitoring time is set, and the process returns to the main flow.

Here, the next monitoring time is reset when it is determined that the SOC is not less than the charge threshold value in step S26. Specifically, estimated time for which the SOC is not less than the charge threshold value is calculated based on the current SOC, the current monitoring time, and the like, and this time is set as the next monitoring time. When it is determined that the SOC is less than the charge threshold value in step S26, the same monitoring time as the last monitoring time is set as the next monitoring time since this is an appropriate monitoring time as described above.

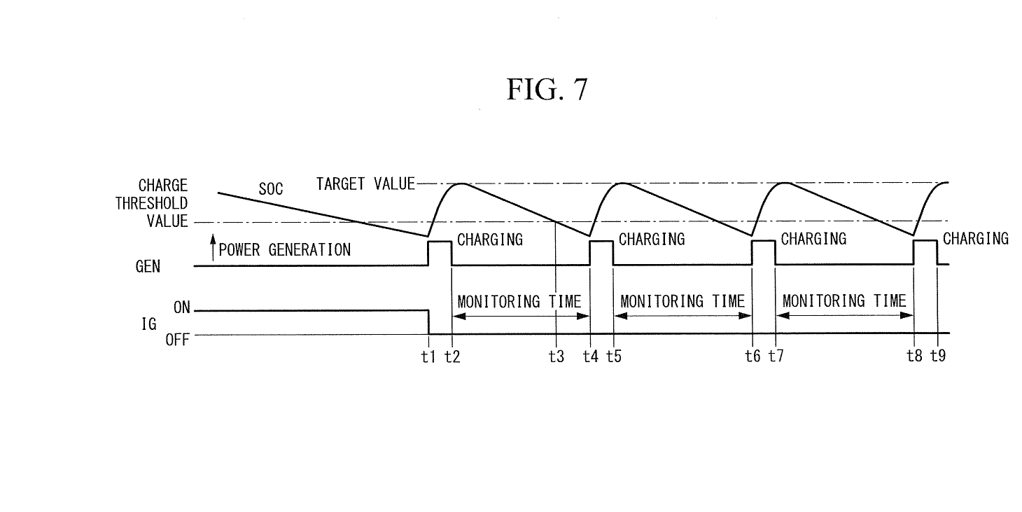

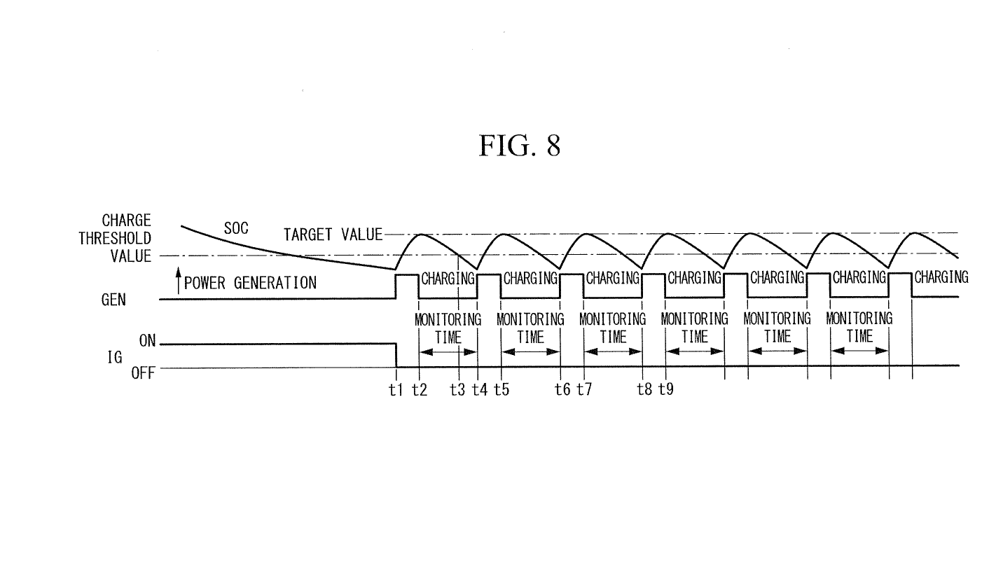

Next, the above operation of the battery controller will be described based on timing charts shown in FIGS. 7 and 8.

The timing chart shown in FIG. 7 shows an example in the case of the new battery 19. In the example of this timing chart, the first state is a state where charging is not performed even though the ignition switch is in the ON state. For example, this state is a state where the entire generated power is supplied to the drive motor 11 even though the internal combustion engine 12 is driven and the electric power from the battery 19 is also supplied to the drive motor 11.

First, before time t1, the battery 19 is in a discharge state. Accordingly, the SOC is gradually reduced. Then, at time t1, the hybrid vehicle 10 stops and changes the ignition switch to an OFF state. At this time t1, since the SOC is less than the charge threshold value, driving of the internal combustion engine 12 is continued and the battery 19 is charged by the power generated by the motor for power generation 13.

When the SOC reaches a target value or higher at time t2, the charging of the battery 19 is stopped and accordingly the driving of the internal combustion engine 12 is stopped. In this case, the battery 19 is not overcharged since the SOC is charged up to the target value that does not exceed the upper limit of the available range. Then, when the neglect mode is started, the monitoring time is set and the counting of the monitoring time (in FIG. 7, from time t2 to time t4) is started.

After time t2, the charging of the battery 19 is stopped and the SOC is gradually reduced. At time t3, the SOC becomes less than the charge threshold value. At time t4 immediately after time t3, the monitoring time passes, and determination regarding whether or not the SOC has become less than the charge threshold value is performed. At this time t4, it is determined whether or not the SOC has become less than the charge threshold value before the SOC reaches the lower limit of the available range. In addition, since the SOC is less than the charge threshold value at time t4, the internal combustion engine 12 is started and power generation of the motor for power generation 13 is started. As a result, charging of the battery 19 by this generated power is started.

Then, similar to time t2, at time t5, when the SOC reaches a target value or higher driving of the internal combustion engine 12 is stopped and accordingly the charging of the battery 19 is stopped. In this case, since the last monitoring time was an appropriate monitoring time, the same monitoring time as the last monitoring time is set as the next monitoring time, and the counting of the monitoring time is started. Then, until the ignition switch changes to an ON state, a determination regarding whether or not the SOC has become less than the charge threshold value is performed whenever the set monitoring time passes as time t6 to t9. When it is determined that the SOC has become less than the charge threshold value, the battery 19 is charged until the SOC reaches the target value.

The timing chart shown in FIG. 8 shows an example when the battery 19 has deteriorated to some extent. When the battery 19 has deteriorated to some extent, the available range is narrow since the degree of deterioration is large compared with that when the battery 19 described above is a new battery. In addition, when the degree of deterioration of the battery 19 is large, the time until the SOC becomes less than the charge threshold value due to self-discharge or the like is relatively shorter than that when the battery 19 is a new battery. For this reason, the monitoring time is set to be short and accordingly the frequency of charging is also relatively increased. The graphs shown in FIGS. 7 and 8 are horizontal axes of the same scale. In FIG. 8, the same time number is given to the time at which the same processing as in FIG. 7 is performed, and a repeated explanation will be omitted here.

Therefore, according to the battery controller of the embodiment described above, when the neglect state of a vehicle is detected in steps S12 and S13, the monitoring time is set based on the degree of deterioration of the battery 19 and the current SOC of the battery 19, and it is determined whether or not the battery 19 needs to be charged in step S26 in order to monitor the SOC of the battery 19 after the passage of the monitoring time. As a result, even if unintentional neglect of the hybrid vehicle 10 occurs, it is possible to determine whether or not the battery 19 needs to be charged using appropriate monitoring time according to the degree of deterioration of the battery 19. Therefore, since the battery 19 can be charged by the motor for power generation 13 before the battery 19 is over-discharged, the burden on the battery 19 is reduced and accordingly the shortening of the service life can be suppressed.

In addition, since the SOC of the battery 19 is monitored after the passage of the monitoring time, it is possible to suppress the power consumption according to the monitoring of the SOC and accordingly to save energy, compared with a case where the SOC of the battery 19 is always monitored.

In addition, since the monitoring time is set based on the available range and the current SOC of the battery 19, it is possible to determine whether or not the battery 19 needs to be charged in step S26 and set the monitoring time so that the battery 19 is charged by the motor for power generation 13 before the SOC of the battery 19 deviates from the available range, it is possible to prevent a situation where the SOC becomes less than the available range and accordingly the battery 19 is over-discharged.

In addition, since the charging is stopped when it is determined that the SOC has become equal to or higher than the target value, it is possible to charge the battery 19 so as not to exceed the available range. Accordingly, since an increase in the burden on the battery 19 due to overcharging is prevented, the shortening of the service life of the battery 19 can be suppressed.

In addition, the monitoring time is set to be shorter as the degree of deterioration of the battery 19 becomes larger. Accordingly, even if the deterioration of the battery 19 is in process, it is possible to prevent the battery 19 from becoming over-discharged by charging the battery 19 in a timely manner before the SOC of the battery 19 becomes less than the lower limit of the available range.

In addition, when the SOC of the battery 19 when the ignition switch is turned off, is an SOC that needs charging, it is possible to charge the battery 19 in a state where the internal combustion engine 12 is still warm without stopping the internal combustion engine 12. Therefore, compared with a case of charging the battery 19 by driving the internal combustion engine 12 in a cold state immediately after start, it is possible to reduce exhaust emissions and to further improve the fuel efficiency.

In addition, in steps S06 and S27, it is possible to notify the operator that the internal combustion engine 12 is driven to charge the battery 19 when opening the engine compartment of the hybrid vehicle 10 for maintenance or the like. Therefore, it is possible to reduce the burden of the operator such as a work to check the situation or the like.

In addition, this invention is not limited to the configuration of the embodiment described above, and the design may be changed without deviating from the subject matter of this invention.

For example, although the series type hybrid vehicle 10 has been described as an example in the above embodiment, the present invention is not limited to the series type. The present invention may also be applied to a parallel type hybrid vehicle or an intermediate type hybrid vehicle between the series type and the parallel type as long as the vehicle has the internal combustion engine 12 capable of driving the motor for power generation 13.

In addition, the case of charging the battery 19 when the SOC is less than the charge threshold value when the ignition switch is changed from ON to OFF has been described. However, the battery 19 may always be charged when the ignition switch is changed from ON to OFF except for a case where the SOC is equal to or higher than the target value, a case where there is not enough fuel in the internal combustion engine 12, or the like.

In addition, although the case in which the notification unit that sends a notification indicating that the battery 19 is being charged is provided has been described, the notification unit may not be provided.

In addition, the case in which the monitoring time is set to be shorter as the deterioration of the battery 19 progresses, has been described. However, in addition to this configuration, the charge threshold value when monitoring the SOC may be set to a higher value as the battery 19 deteriorates, so that it is prevented that the SOC becomes less than the lower limit of the available range.

### INDUSTRIAL APPLICABILITY

According to the battery controller of a vehicle of the present invention, even if unintentional neglect of the vehicle occurs, it is possible to determine whether or not charging is necessary using appropriate monitoring time according to the degree of deterioration of the battery. Accordingly, the battery can be charged by the generator before the battery is over-discharged. Therefore, since the burden on the battery is reduced, the shortening of the service life can be suppressed. In addition, since the remaining capacity of the battery is monitored after the passage of the monitoring time, it is possible to suppress power consumption for monitoring and therefore to save energy, compared with a case where the remaining capacity of the battery is always monitored.

### REFERENCE SIGNS LIST

10: hybrid vehicle
12: internal combustion engine
13: motor for power generation (generator)
18: MGECU (control unit)
19: battery
21: rotation sensor (detector)
23: battery current sensor (detector)
24: battery temperature sensor (detector)
25: voltage sensor (detector)
30: neglect operation input unit
S21: monitoring time setting unit
S12, S13: neglect state detector
S02: degree-of-deterioration determination unit
S06, S27: notification unit
S26: charging necessity determination unit
S08, S30: charge target value setting unit

1. A battery controller of a vehicle comprises:
an internal combustion engine;
a generator that generates electricity by driving of the internal combustion engine;
a battery charged by an electric power generated by the generator;
a battery state detector that detects a battery state including a remaining capacity of the battery;
a degree-of-deterioration determination unit that determines a degree of deterioration of the battery based on the battery state detected by the battery state detector;
a neglect state detector that detects a neglect state of the vehicle;
a monitoring time setting unit that sets a monitoring time to monitor the remaining capacity based on the degree of deterioration determined by the degree-of-deterioration determination unit and a current remaining capacity of the battery detected by the battery state detector when the neglect state of the vehicle is detected by the neglect state detector; and
a charging necessity determination unit that determines whether or not the battery needs to be charged after the monitoring time set by the monitoring time setting unit passes,
wherein charging of the battery by the generator is started when the charging necessity determination unit determines that the battery needs to be charged.

2. The battery controller of the vehicle according to claim 1,
wherein the monitoring time setting unit calculates an available range of a full capacity of the battery based on the degree of deterioration determined by the degree-of-deterioration determination unit, and sets the monitoring time based on the available range and the current remaining capacity of the battery.

3. The battery controller of the vehicle according to claim 2, further comprising:
a charge target value setting unit that sets a target value of an amount of charging of the battery based on the available range,
wherein the charging of the battery by the generator is controlled based on the target value set by the charge target value setting unit.

4. The battery controller of the vehicle according to claim 1,
wherein the monitoring time setting unit sets the monitoring time according to the degree of deterioration.

5. The battery controller of the vehicle according to claim 1,
wherein the charging necessity determination unit determines whether or not the battery needs to be charged when an ignition switch is turned off, makes the battery be charged by the generator when the charging necessity determination unit determines that the battery needs to be charged, and stops the internal combustion engine after the charging of the battery ends.

6. The battery controller of the vehicle according to claim 1, further comprising:
a notification unit that notifies that the battery is being charged by the generator.

7. The battery controller of the vehicle according to claim 1,
wherein the monitoring time setting unit sets a new monitoring time whenever the monitoring time passes.

8. The battery controller of the vehicle according to claim 1,
wherein the neglect state detector detects the neglect state when a predetermined time for detecting the neglect state has passed in a state where an ignition switch is off.

9. The battery controller of the vehicle according to claim 1, further comprising:
a neglect operation input unit capable of inputting an indication that the vehicle is to be in the neglect state,
wherein the neglect state detector detects the neglect state when there is an operation input to the neglect operation input unit.
